(19) United States
(12) Patent Application Publication
(10) Pub. No.: US 2011/0040016 A1
(43) Pub. Date: Feb. 17, 2011

(54) CURABLE COMPOSITIONS THAT FORM A HIGH MODULUS POLYUREA

(76) Inventors: George Yakulis, JR., Allison Park, PA (US); Edward R. Millero, JR., Gibsonia, PA (US); Howard L. Senkfor, South Euclid, OH (US)

Correspondence Address: Intellectual Property Law Department;PPG Industries, Inc., 39th Floor, One PPG Place, Pittsburgh, PA, 15272, US

(21) Appl. No.: 12/557,025

(22) Filed: Sep. 10, 2009

Related U.S. Application Data
(63) Continuation-in-part of application No. 12/426,411, filed on Apr. 20, 2009.
(60) Provisional application No. 61/099,752, filed on Sep. 24, 2008.
(60) Provisional application No. 61/046,515, filed on Apr. 21, 2008.

(51) Int. Cl. C08K 3/34; C09D 175/02

(52) U.S. Cl. 524/447; 525/452; 524/589; 524/445; 525/424

(57) ABSTRACT

Curable, two-package compositions are provided comprising a first and second reactive package. The first reactive package comprises:
a) a polyether functional polyamine;
b) a polyamine comprising an aspartic ester functional polyamine and/or one or more hindered amines; and
c) an aliphatic secondary polyamine.

The second reactive package comprises a polyisocyanate having a viscosity of ≦2000 centipoise (cPs) at a temperature≧7° C. The curable composition, upon mixing of the reactive packages at ambient temperature, demonstrates a gel time of less than 120 seconds, and is suitable for use as a mortar or caulk.

### CROSS-REFERENCE TO RELATED APPLICATIONS

This application is a continuation-in-part of U.S. patent application Ser. No. 12/426,411, filed Apr. 20, 2009, entitled: “LOW TEMPERATURE APPLICATION COATING COMPOSITION COMPRISING POLYUREA AND A PHOSPHORUS-CONTAINING POLYOL AND FOOTWEAR COMPRISING POLYUREA,” incorporated herein in its entirety, which application in turn claims the benefit of U.S. Provisional Patent Application Ser. No. 61/099,752 filed Sep. 24, 2008, entitled: “LOW TEMPERATURE APPLICATION COATING COMPOSITION COMPRISING POLYUREA AND A PHOSPHORUS-CONTAINING POLYOL” and U.S. Provisional Patent Application Ser. No. 61/046,515 filed Apr. 21, 2008, entitled: “FOOTWEAR COMPRISING POLYUREA”.

### FIELD OF THE INVENTION

The present invention is directed to curable, two-package compositions comprising a first and second reactive package that combine to form polyureas.

### BACKGROUND

Coating compositions are used in a wide variety of industries. Such industries may include but are not limited to landcraft such as cars, trucks, sport utility vehicles, motorcycles; watercraft such as boats, ships and submarines; aircraft such as airplanes and helicopters, industrial such as commercial equipment and structures including walls and roofs; construction such as construction vehicles and structures including walls and roofs, military such as military vehicles, for example tanks and humvees, and military structures including walls and roofs, for example, ammunition cases and battery enclosures; mining industry such as construction of mine seals, mine ventilation stoppings, rescue chambers, and the like.

In these industries, coatings serve a variety of purposes such as protecting various components against damage due to corrosion, abrasion, impact, chemicals, ultraviolet light, flame and heat, and other environmental exposure as well imparting ballistic and blast mitigation properties to the components onto which they are deposited. Accordingly, considerable efforts have been expended to develop coating compositions with improved properties.

### SUMMARY OF THE INVENTION

The present invention is directed to curable, two-package compositions comprising a first and second reactive package. The first reactive package comprises:
a) a polyether functional polyamine;
b) a polyamine comprising an aspartic ester functional polyamine and/or a hindered amine of the structure I:

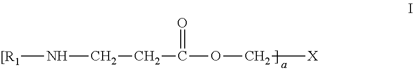

where R₁ represents a hydrocarbon radical; X represents an organic group; and a is an integer from 1 to 20; and/or II:

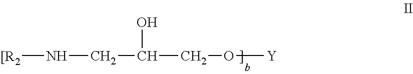

where R₂ represents a hydrocarbon radical; Y represents an organic group; and b is an integer from 1 to 10; and
c) an aliphatic secondary polyamine different from (a) and (b).

The second reactive package comprises a polyisocyanate having a viscosity of 2000 centipoise (cPs) at a temperature 7° C. The curable composition, upon mixing of the reactive packages at ambient temperature, demonstrates a gel time of less than 120 seconds. In particular embodiments of the present invention, the curable compositions form polyurea compositions demonstrating high Young's modulus and tensile strength at ambient temperature, at two hours after mixing of the reactive packages. This composition is suitable for but not limited to use as a mortar or caulk.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges contained therein. Plural encompasses singular and vice versa. “Including” and like terms are open ended; that is, they mean “including but not limited to”. For example, while the invention has been described herein including the claims in terms of “a” polyurea, “a” polyurethane, “an” isocyanate, “an” amine, “a” polyol, “a” polythiol, “a” prepolymer, “a” catalyst, and the like, mixtures of all of such things can be used. Also, as used herein, the term “polymer” is meant to refer to prepolymers, oligomers and both homopolymers and copolymers; the prefix “poly” refers to two or more.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

By “ambient temperature” is meant a temperature in the range of 70 to 80° F. (21.1 to 26.7° C.). Properties of the compositions of the present invention were typically measured at 23° C. unless otherwise noted.

Viscosity measurements used herein were measured using a PHYSICA MCR 301 rheometer (commercially available from Antone Paar GmbH, Austria) having a 50 mm/1° cone plate. The sample that is to be measured is loaded onto the cone plate at 23.89° C. and viscosity measurements are taken at a constant shear rate of 1000 s⁻¹ at the appropriate temperatures.

As used herein, the tensile strength and/or % elongation of a coating composition, after it has been applied onto a substrate and cured, was tested pursuant to the ASTM D638-08 standard.

Reference to any monomer(s) herein refers generally to a monomer that can be polymerized with another polymerizable compound such as another monomer or polymer. Unless otherwise indicated, it should be appreciated that once the monomer components react with one another to form the compound, the compound will comprise the residues of the monomer components.

### Curable Composition

The present invention is directed to a curable, two-package composition comprising a first and second reactive package. The two packages are typically mixed together immediately prior to curing, such as immediately prior to application to a substrate. The second reactive package has a viscosity of ≦2000 cPs at a temperature of ≧7° C. In certain embodiments, the first reactive package further comprises an additional resin that is different from any of the amines, and that may or may not be reactive with the polyisocyanate. The curable composition, upon mixing of the reactive packages at ambient temperature, demonstrates a gel time of less than 120 seconds, often less than 100 seconds, and is suitable for use as a mortar or caulk.

In some embodiments, the composition, after application to a substrate and after curing, demonstrates a % elongation of ≧10. For example, in some embodiments, the % elongation can be ≧100, such as 200.

### First Reactive Package

### Amine Component

The first reactive package comprises polyamines; often diamines and/or triamines. For example, the first reactive package comprises (a) a polyether functional polyamine; i.e., polyoxyalkyleneamines, which comprise two or more primary or secondary amino groups attached to a backbone, derived, for example, from propylene oxide, ethylene oxide, butylene oxide or a mixture thereof. Examples of such amines include those available under the designation JEFFAMINE, such as, without limitation, JEFFAMINE D-230, D-400, D-2000, HK-511, ED-600, ED-900, ED-2003, T-403, T-3000, T-5000, SD-231, SD-401, SD-2001, and ST-404 (Huntsman Corporation). Such amines have an approximate molecular weight ranging from 200 to 7500. The polyether functional polyamine is typically present in the first reactive package in an amount of up to 30 percent by weight, based on the total weight of solids in the first reactive package.

The first reactive package further comprises (b) a polyamine comprising an aspartic ester functional polyamine and/or a hindered amine of the structure I:

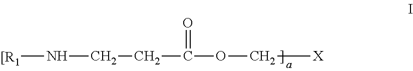

where R₁ represents a hydrocarbon radical; X represents an organic group; and a is an integer from 1 to 20; and/or II:

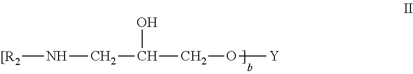

where R₂ represents a hydrocarbon radical; Y represents an organic group; and b is an integer from 1 to 10. The hindered amines are described in detail in U.S. Pat. No. 6,369,189, at column 4, line 16, to column 6, line 21, incorporated herein by reference.

Suitable aspartic ester functional amines include those available under the name DESMOPHEN such as DESMOPHEN NH1220, an aspartic ester functional amine containing linear groups. Others include DESMOPHEN NH 1420 and DESMOPHEN NH 1520 (Bayer Materials Science LLC). The aspartic ester functional polyamine is typically present in an amount of 30 to 65 percent by weight, based on the total weight of solids in the first reactive package.

The hindered amines may be represented by Formula I:

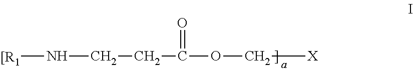

wherein R₁ is a hydrocarbon radical that may be represented by an alkyl group, an aryl-alkyl group, a hydroxy-alkyl group or an alkoxy-alkyl group. Exemplary hydrocarbons include t-butyl, t-octyl, C₁₂-C₁₄ and C₁₆-C₂₂ alkyls cyclohexane; X is an organic group having a valence of a. X may be propyl, ethyl, ethanol, methyl, methynol, 2-ethyl hexyl, lavryl hexane, tripropyl hexane, cyclohexane, isobornyl and the like, and is preferably propyl, methyl, methanol or isobornyl; and a represents integers having a value in the range of 1 to 20, more preferably 1 to 15, and most preferably 1 to 10. Hindered amine adducts of Formula I may be prepared by reacting a primary amine with an acrylate.

The primary amine may have the formula R—NH₂, where R is a hydrocarbon radical that may be represented by an alkyl group, an aryl-alkyl group, a hydroxy-alkyl group, or an alkoxy-alkyl group. Examples of suitable primary amines include butylamine, pentylamine, hexylamine, heptylamine, octylamine, nonylamine, decylamine and polyoxypropylene amine. R is preferably a tertiary alkyl group containing from about 4 to about 30 carbon atoms, such as t-butyl or t-octyl. Examples of preferable tertiary alkyl primary amines include, but are not limited to, tertiary-butyl primary amine, tertiary-octyl primary amine, 1-methyl-1-amino-cyclohexane, tertiary-tetradecyl primary amine, tertiary-hexadecyl primary amine, tertiary-octadecyl primary amine, tertiary-octacosanyl primary amine, and other primary amines containing higher tertiary C₈ to C₃₀ alkyl groups. Mixtures of tertiary alkyl primary amines may also be used. A suitable class of amines are commercially available under the Primene® tradename from Rohm and Haas Company of Philadelphia, Pa. Tertiary alkyl primary amines and methods for their preparation are known to those of ordinary skill in the art.

Suitable acrylates include those having the formula:

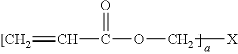

wherein X and a are as defined above. Suitable acrylate oligomers for preparing the hindered amine adducts of Formula I include tripropylene glycol diacrylate, trimethylolpropane triacrylate, isobornyl acrylate, pentaerythritol triacrylate, dipentaerythritol hexaacrylate, hexanediol diacrylate, cyclohexane-dimethanol diacrylate, tetraethylene glycol diacrylate, diacrylate of bisphenol A based epoxy, triacrylate of glycerol, ethoxylated trimethylolpropane triacrylate, acrylate of epoxidized soya oil, and urethane acrylates based on isophorone diisocyanate and petaerythritol triacrylate.

The hindered amines may also be represented by Formula II:

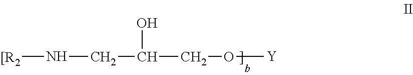

wherein R₂ is a hydrocarbon radical that may be represented by an alkyl group, an aryl-alkyl group, a hydroxy-alkyl group or an alkoxy-alkyl group. Exemplary hydrocarbons include t-butyl, t-octyl, C₁₂ and C₁₄ and C₁₆-C₂₂ alkyls and cyclohexane; Y represents an organic group having a valence b and represents the hydrocarbon group obtained by removal of the glycidyl ether groups from epoxide resins based on Bisphenol A, Bisphenol F, tetrabromobisphenol A, phenol-formaldehyde condensates, hydrogenated Bisphenol A, resocinol, sorbitol, etc. Preferably, Y represents the hydrocarbon group obtained by removal of the glycidyl ether groups from epoxide resins based on Bisphenol A or Bisphenol F; and b represents integers having a value in the range of 1 to 10, more preferably 1 to 8, and most preferably 1 to 6. Hindered amine adducts of Formula II may be prepared by reacting a primary amine with an epoxide or glycidyl ether.

The primary amine may be selected from the group described above, with tertiary alkyl primary amines preferable. Suitable epoxides or glycidyl ethers include those having the formula:

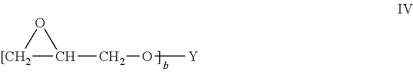

wherein Y and b are as described above. Suitable epoxide resins for preparing the hindered amine adducts are ones based on Bisphenol A and Bisphenol-F, such as, but not limited to, the diglycidyl ether of Bisphenol A, diglycidyl ether of Bisphenol-F, diglycidyl ether of tetrabromobisphenol A, epoxy novolacs based on phenol-formaldehyde condensates, epoxy novolacs based on phenol-cresol condensates, epoxy novolacs based on phenol-dicyclopentadiene condensates, diglycidyl ether of hydrogenated Bisphenol A, diglycidyl ether of resorcinol, tetraglycidyl ether of sorbitol, tetra glycidyl ether of methylene dianiline or mixtures thereof; and glycidyl ethers of the following alcohols: 2-ethylhexanol, alcohols containing from 8 to 14 carbon atoms, cresol, p-tertiary butyl phenol, nonyl phenol, phenol, neopentyl glycol, 1,4-butanediol, cyclohexane dimethanol, propylene glycol, dibromo neopentyl glycol, trimethylol propane, trimethylol ethane, and n-butanol. Preferably, the epoxide has an average epoxide equivalent weight (EEW) of from about 120 to about 2000, and more preferably from about 140 to about 1000.

The hindered amines of Formula I and/or II typically comprise from 0 to about 100 weight percent of the hindered amine adduct represented by Formula I, often 30 to 100 weight percent; and 0 to 70 weight percent of the hindered amine adduct represented by Formula II.

The hindered amine adducts of Formulas I and II may be prepared in accordance with procedures that are known in the art. Typically, the amine adduct is formed by reacting an amine with the amine-reactive component. These reactions can be carried out in suitable reaction vessels at temperatures ranging from about 40 to 150° C. Preferably, a nitrogen or other inert gas cover may be used to exclude oxygen from the reaction. The hindered amine adducts may be prepared separately and mixed after the individual synthesis of each adduct, or more conveniently, the hindered amine adducts can be prepared in a single reaction vessel either simultaneously or in sequence.

When the polyamine (b) comprises both an aspartic ester functional polyamine and one or more of the hindered amines, they may be combined in any weight ratio. For example, the weight ratio of aspartic ester functional polyamine to hindered amine may be 1:10 to 10:1.

The first reactive package further comprises (c) an aliphatic secondary polyamine different from (a) and (b). Such polyamines are often diamines. Suitable cycloaliphatic diamines include, without limitation, JEFFLINK 754 (Huntsman Corporation) and CLEARLINK 1000 (Dorf-Ketal Chemicals, LLC). Other suitable secondary amines that can be used in the present invention include the reaction products of materials comprising primary amine functionality, such as those described herein, with acrylonitrile. For example, the secondary amine can be the reaction product of 4,4′-diaminodicyclohexylmethane and acrylonitrile. Alternatively, the secondary amine can be the reaction product of isophorone diamine and acrylonitrile, such as POLYCLEAR 136 (available from BASF/Hansen Group LLC) and HXA CE425 (available from Hansen Group LLC). The aliphatic secondary diamine often has an amine equivalent weight of up to 200, more often up to 162. The aliphatic secondary polyamine is present in the first reactive package in an amount of 10 to 40 percent by weight, based on the total weight of solids in the first reactive package.

In certain embodiments of the present invention, at a temperature≧7° C., such as a temperature ranging from 7° C. to 13° C., the viscosity of the first reactive package is ≦1700 centipoise, such as ≦1500 centipoise or 1000 centipoise. The amine component in the first reactive package may be referred to herein as a “curative” because it will react or cure with the isocyanate to form a polyurea. In certain embodiments, the ratio of equivalents of isocyanate groups to equivalents of amine groups is greater than 1 and the isocyanate component and the amine component can be applied to a substrate at a weight or volume mixing ratio of 1:1.

Additional polyamines may be included in the first reactive package provided that upon mixing of the reactive packages at ambient temperature, the curable composition demonstrates a gel time of less than 120 seconds. Suitable additional polyamines are numerous and can vary widely. Non-limiting examples of suitable polyamines can include but are not limited to primary and secondary amines, and mixtures thereof, such as any of those listed herein. Amine terminated polyureas may also be used. Amines comprising tertiary amine functionality can be used provided that the amine further comprises at least two primary and/or secondary amino groups. In certain embodiments, wherein the isocyanate functional prepolymer comprises a polyamine, the ratio of equivalents of isocyanate groups (NCO) to equivalents of amine groups (NH) can be greater than 1.

In certain embodiments, the additional amine may include, for example, monoamines, or polyamines having at least two functional groups such as di-, tri-, or higher functional amines; and mixtures thereof. In further embodiments, the additional amine may be aromatic or aliphatic such as cycloaliphatic, or mixtures thereof. Non-limiting examples of suitable polyamines can include aliphatic polyamines such as, but not limited to, ethylamines, isomeric propylamines, butylamines, pentylamines, hexylamines, and cyclohexylamines. Suitable aromatic polyamines include benzylamines and secondary amines such as UNILINK 4200, available from Dorf Ketal, typically used in amounts of 10 to 25, often 20 to 25 percent by weight, more often 23 percent by weight, based on the total weight of solids in the first reactive package. Suitable primary polyamines include, but are not limited to, ethylene diamine, 1,2-diaminopropane, 1,4-diaminobutane, 1,3-diaminopentane (DYTEK EP, Invista), 1,6-diaminohexane, 2-methyl-1,5-pentane diamine (DYTEK A, Invista), 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′-diaminodicyclohexyl methane, 4,4′-diaminodicyclohexyl methane (PACM-20, Air Products) and 3,3′-dialkyl-4,4′-diaminodicyclohexyl methanes (such as 3,3′-dimethyl-4,4′-diaminodicyclohexyl methane (DIMETHYL DICYKAN or LAROMIN C260, BASF; ANCAMINE 2049, Air Products) and 3,3′-diethyl-4,4′-diaminodicyclohexyl methane), 2,4- and/or 2,6-diaminotoluene, 3,5-diethyltoluene-2,4-diamine, 3,5-diethyltoluene-2,6-diamine, 3,5-dimethylthio-2,4-toluenediamine, 3,5-dimethylthio-2,4-toluenediamine, 2,4′- and/or 4,4′-diaminodiphenyl methane, dipropylene triamine, bis hexamethylene triamine, or combinations thereof. Additional polyoxyalkyleneamines are also suitable.

Other amines that can be used in the present invention include adducts of primary polyamines with mono or polyepoxies such as the reaction product of isophorone diamine with CARDURA E-10P.

The present curable compositions may also comprise one or more amines such as those describe in U.S. patent application Ser. Nos. 11/611,979, 11/611,984, 11/611,988, 11/611,982, and 11/611,986, all of which are incorporated in pertinent part herein by reference.

### Second Reactive Package

### Isocyanate Component

As noted above, at a temperature≧7° C., such as a temperature ranging from 7° C. to 13° C., the viscosity of the second reactive package is ≦2000 centipoise (cP). In certain embodiments the viscosity is ≦1800, or ≦1500. In some embodiments, the viscosity of the first component ranges from 1100 centipoise to 1600 centipoise at a temperature ranging from 13° C. to 10° C.

As used herein, the term “isocyanate” includes unblocked isocyanate compounds capable of forming a covalent bond with a reactive group such as a hydroxyl, thiol or amine functional group. Thus, isocyanate can refer to “free isocyanate”, which will be understood to those skilled in the art. In certain embodiments, the isocyanate of the present invention can be monofunctional (containing one isocyanate functional group (NCO)) or the isocyanate used in the present invention can be polyfunctional (containing two or more isocyanate functional groups (NCOs)). The isocyanate can also be blocked. Combinations of any isocyanates and/or isocyanate functional prepolymers can be used according to the present invention.

Suitable isocyanates for use in the present invention are numerous and can vary widely. Such isocyanates can include those that are known in the art. Non-limiting examples of suitable isocyanates can include monomeric and/or polymeric isocyanates. The isocyanates can be selected from monomers, prepolymers, oligomers, or blends thereof. In an embodiment, the isocyanate can be C₂-C₂₀ linear, branched, cyclic, aromatic, aliphatic, or combinations thereof.

Suitable isocyanates for use in the present invention may include but are not limited to isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

Non-limiting examples of aromatic isocyanates for use in the present invention may include but are not limited to phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate; and mixtures thereof.

In certain embodiments, isocyanate monomer may be used. It is believed that the use of an isocyanate monomer (i.e., residual-free monomer from the preparation of prepolymer) may decrease the viscosity of the polyurea composition thereby improving its flowability, and may provide improved adhesion of the polyurea coating to a previously applied coating and/or to an uncoated substrate. In alternate embodiments of the present invention, at least 1 percent by weight, or at least 2 percent by weight, or at least 4 percent by weight of the isocyanate component comprises at least one isocyanate monomer.

In certain embodiments of the present invention, the isocyanate can include oligomeric isocyanate such as but not limited to dimers such as the uretdione of 1,6-hexamethylene diisocyanate, trimers such as the biuret and isocyanurate of 1,6-hexanediisocyanate and the isocyanurate of isophorone diisocyanate, allophonates and polymeric oligomers. Modified isocyanates can also be used, including but not limited to carbodiimides and uretone-imines, and mixtures thereof. Suitable materials include, without limitation, those available under the designation DESMODUR from Bayer Corporation of Pittsburgh, Pa. and include DESMODUR N 3200, DESMODUR N 3300, DESMODUR N 3400, DESMODUR XP 2410 and DESMODUR XP 2580, which is most suitable.

In some embodiments, the isocyanate component comprises an isocyanate functional prepolymer formed from a reaction mixture comprising an isocyanate and another material. Any isocyanate known in the art, such as any of those described above, can be used in the formation of the prepolymer. As used herein, an “isocyanate functional prepolymer” refers to the reaction product of isocyanate with polyamine and/or other isocyanate reactive group such as polyol; the isocyanate functional prepolymer has at least one isocyanate functional group (NCO).

In certain embodiments of the present invention, an isocyanate functional prepolymer comprises isocyanate that is pre-reacted with a material comprising a flame retardant material, such as a phosphorus-containing polyol. Suitable isocyanate functional prepolymers comprising a flame retardant material are disclosed in Paragraphs [0017]-[0023] of U.S. Ser. No. 12/122,980, incorporated by reference herein. As described in that excerpt, in certain embodiments the phosphorus containing polyol can itself be the reaction product of a phosphorus containing polyol, sometimes referred to as an “initial” phosphorus containing polyol, and another compound.

In some embodiments, however, the polyol used in the formation of the pre-polymer is not a phosphorus containing polyol. Suitable non-phosphorous containing polyols include polytetrahydrofuran materials such as those sold under the tradename TERATHANE (e.g., TERATHANE 250, TERATHANE 650, TERETHANE 1000 available from Invista Corporation).

The curable composition of the present invention, which can exhibit improved flame and/or heat resistance, can comprise any phosphorus-containing isocyanate prepolymer. As used herein, the term “flame retardant”, “flame resistant”, “heat retardant”, “heat resistant” and the like typically refers to, for example, the ability to withstand flame or heat without igniting, the ability to self-extinguish quickly when ignited, the ability to minimize generating heat as a material burns, the ability to minimize the spreading or propagation a of flame and/or minimize the toxicity or amount of smoke generated under burning conditions. As used herein, the terms “improved flame resistance” and “improved heat resistance” means any degree of improved flame resistance or heat resistance, respectively, that is demonstrated by a composition with flame retardant material as compared to a composition, such as the same composition, without flame retardant material.

### Additional Ingredients

In certain embodiments, the curable composition may comprise one or more additional ingredients in the first and/or second reactive package. Similarly, the composition may comprise one or more additional components that are mixed with the first and second reactive packages prior to use. Additional ingredients may include, for example, a flame retardant material in addition to or instead of an isocyanate functional pre-polymer comprising a flame retardant material as described herein. The additional flame retardant material can be added to the isocyanate and/or the amine component of the present invention.

Any flame retardant material known in the art can be used as the additional flame retardant material in the present invention. Such flame retardants can include, for example, those described in Paragraphs [0035] and [0038] of U.S. patent application Ser. No. 12/122,980, which paragraphs are incorporated by reference herein. Other suitable flame retardant materials include, without limitation, the flame retardant polymers disclosed in U.S. Pat. Nos. 6,015,510 (column 4, line 31 thru column 5, line 41, which excerpts are incorporated by reference herein) and 5,998,503 (column 4, line 31 thru column 5, line 41, which excerpts are incorporated by reference herein), halogenated phosphates or halogen free phosphates, powdered or fumed silica, layered silicates, aluminum hydroxide, brominated fire retardants, tris(2-chloropropyl) phosphate, tris(2,3-dibromopropyl)phosphate, tris(1,3-dichloropropyl)phosphate, diammonium phosphate, various halogenated aromatic compounds, antimony oxide, alumina trihydrate, polyvinyl chloride and the like, and mixtures thereof. In certain embodiments, the flame retardant material is tris(2-chloropropyl) phosphate, which is available from Supresta under the designation FYROL PCF. When the flame retardant is a low viscosity liquid, it also can reduce the viscosity of the isocyanate and/or amine component, enhancing sprayability. In certain embodiments, the flame retardant material may include a phosphinic salt and/or diphosphinic salt, such as those described in United States Patent Publication Nos. 200510004277A1 and 200510004278A1, from Paragraph [0025] to Paragraph [0070] in both publications, which paragraphs are incorporated by reference herein.

In some embodiments, anti-oxidants, hindered amine light stabilizing compounds, or combinations thereof may be used in the present invention as a flame retardant. Suitable anti-oxidants that may be used in the present invention include phenolic and/or phosphorus based anti-oxidants. Suitable examples of such anti-oxidants are disclosed in Table 1 of U.S. Pat. Pub. No. 2007/0203269, which Table is incorporated by reference in its entirety herein, ANNOX IC-14 (available from Chemtura Corp). Suitable hinder amine light stabilizing compounds that may be used in the present invention include polymeric hinder amine light stabilizing compounds, monomeric hindered amine light stabilizing compounds, or combinations thereof. Suitable polymeric hindered amine light stabilizing compounds include TINUVIN 266, CHIMASORB 199FL, CHIMASORB 944 FDL, TINUVIN 622 (all of which are available from Ciba), CYASORB UV3529, CYASORB UV 3346 (both of which are available from Cytec Industries), polymers with hindered amine light stabilizing functionality, or combinations thereof. Suitable monomeric hinder amine light stabilizing compounds that may be used in the present invention include CYASORB UV3853 (available from Cytec).

The amount of the flame retardant material used can vary widely depending on the needs of the user. In certain embodiments, the flame retardant in the additional flame retardant material and the isocyanate functional pre-polymer can comprise up to 35 percent by weight based on the total weight of reactants in the coating composition.

The composition according the present invention can further comprise any additional resins and/or additives that will impart to the composition a desired property. For example, in certain embodiments of the present invention, the polyamine component further comprises an additional resin that is different from the amine functional component. The additional resin may or may not be reactive with the polyisocyanate, and may comprise, for example, a polyether, a polyol, a thiol ether, a polycarbonate and/or a polyester. The resin may have mono-, di-, tri- or higher functionality. Such resins, when used, may be present in an amount of 2 to 15 percent by weight, based on the total weight of solids in the first reactive package.

In certain embodiments the curable composition may comprise a resin and/or additive that imparts additional flexibility to a coating. In certain embodiments, such resin can be a polyurethane resin. Flexible polyurethane resins are known in the art, and are also described, for example, in U.S. patent application Ser. No. 11/155,154; 11/021,325; 11/020,921; 12/056,306 and 12/056,304, incorporated in pertinent part herein by reference. The polyurethane itself can be added to the composition comprising polyurea, or the polyurethane can be formed in situ in the polyurea composition. It will be appreciated that polyurethane can be formed by reacting a hydroxyl functional component with an isocyanate, much in the same manner as the amine and isocyanate components described herein react. Thus, a hydroxyl functional component can be mixed with, or used in addition to, the amine component for in situ polyurethane formation.

Additional compositions comprising polyurea that would be suitable for use in the present invention include those described in U.S. patent application Ser. Nos. 11/211,188; 11/460,439; 11/591,312; 11/611,979; 11/611,982; 11/611,984; 11/744,259 and 11/773,051, incorporated by reference in their entirety herein.

The compositions of the present invention may optionally include materials standard in the art such as but not limited to fillers, fiberglass, stabilizers, thickeners, adhesion promoters, catalysts, which are often added to the second reactive package, colorants, antioxidants, UV absorbers, hindered amine light stabilizers, rheology modifiers, flow additives, anti-static agents and other performance or property modifiers that are well known in the art of surface coatings, and mixtures thereof. Suitable rheology modifiers include solid and/or liquid rheology modifiers, which can be organic and/or inorganic based polymers. The rheology modifier may be an inorganic, organic, and/or polymeric material as discussed below, and may further comprise a pigment. Examples of a polymeric rheology modifier are BYK-410, BYK-410 or BYK-430 (available from Byk-Chemie). Inorganic rheology modifiers include, for example, a silica such as fumed silica and/or a clay. The clay may be selected from montmorillonite clays such as bentonite, kaolin clays, attapulgite clays, sepiolite clay, and mixtures thereof. Additionally, the clay may be surface treated as is known in the art. Any suitable surface treatment may be used; for example, one or more amines according to the following structures:

R¹—NR²R³

R¹—N⁺R²R³R⁷

R⁴—C(O)—NR⁵—R⁶—NR²R³

R⁴—C(O)—NR⁵—R⁶—N⁺R²R³R⁷

wherein R¹ and R⁴ are independently C₄-C₂₄ linear, branched, or cyclic alkyl, aryl, alkenyl, aralkyl or aralkyl, R², R³, R⁵ and R⁷ are independently H or C₁-C₂₀ linear, branched, or cyclic alkyl, aryl, alkenyl, aralkyl or aralkyl, and R⁶ is C₁-C₂₄ linear, branched, or cyclic alkylene, arylene, alkenylene, aralkylene or aralkylene. As a non-limiting example, surface treated bentonite may be used, such as the alkyl ammonium bentonites described in U.S. Pat. No. 3,974,125.

In certain embodiments of the invention, the clay may be present in the curable composition at a level of at least 0.5 percent by weight, in some cases at least 1 percent by weight and in other cases at least 1.5 percent by weight, based on the total weight of the curable composition. When the amount of clay is too low, the composition can have poor rheological properties. Also, the clay can be present at up to 8 percent by weight, in some cases up to 5 percent by weight, and in other cases up to 4 percent by weight of the composition. When the amount of clay is too high, the viscosity of the composition can be too high to handle effectively. The amount of clay in the two-package composition can be any value or range between any values recited above. The clay may optionally be present in place of or in combination with other rheology modifiers.

In another embodiment of the invention, the curable composition may include a silica in addition to or in place of clay or other rheology modifiers. Any suitable silica can be used, so long as it is a suitable thixotrope. In a particular embodiment of the invention, the silica is fumed silica. Examples of commercially available silica include CABOSIL M5, available from Cabot Corporation, and AEROSIL 200, from Evonik Industries.

When present, the silica is present in the two-package composition at a level of at least 0.5 percent by weight, in some cases at least 1 percent by weight and in other cases at least 1.5 percent by weight based on the total weight of solids in the composition. When the amount of silica is too low, the composition can have poor rheological properties as well as less than desirable adhesion properties. Also, the silica can be present at up to 8 percent by weight, in some cases up to 5 percent by weight, and in other cases up to 4 percent by weight of the composition. When the amount of silica is too high, the viscosity of the composition can be too high to handle effectively. The amount of silica in the curable composition can be any value or range between any values recited above. Alternatively, the composition of the present invention may be essentially free of rheology modifiers.

Pigments may be included with the rheology modifier or may be added to either reactive package of the composition, or to the composition after mixing of the two reactive packages. Pigments serve several purposes, including coloring and/or rheology control (e.g., thixotropy) of the composition, and may be used in combinations. Pigments include TiO₂, carbon black and/or graphite. In particular embodiments of the present invention, a flame retardant material comprising graphite can be added to the isocyanate and/or the amine component of the coating compositions of the present invention. Suitable graphites are known in the art and can include natural and synthetic graphites. Non-limiting examples of suitable graphites can include expandable graphite and/or exfoliated graphite. In certain embodiments, expandable graphite in the form of a solid or powder is intercalated with an acid such as, but not limited to, organic acids (e.g. acetic acid) and inorganic acids (e.g. H₂SO₄ and HNO₃). Non-limiting examples of such graphites include commercially available graphites under the tradenames NORD-MIN from Nano Technologies, Incorporated and NYAGRAPH including but not limited to NYAGRAPH 35, 251 and 351, from Nyacol, Incorporated. In certain embodiments, if the graphite is added to the first component, the graphite can be substantially compatible with the isocyanate functional prepolymers and the additional isocyanate. examples of fillers and adhesion promoters are further described in U.S. Publication No. 2006/0046068 and U.S. application Ser. No. 11/591,312, hereby incorporated by reference in their entirety. In alternate embodiments, such materials may be combined with the isocyanate component, the amine component, or both. In a further embodiment, at least one of these materials is added to the amine prior to reaction with isocyanate. In certain embodiments, the coating may further comprise small amounts of solvent and in certain embodiments the coating may be substantially solvent-free. “Substantially solvent-free” means that the coating may contain a small amount of solvent, such as 5%, 2%, 1% or less.

In another embodiment, the composition of the present invention may include a colorant. As used herein, the term “colorant” means any substance that imparts color and/or other opacity and/or other visual effect to the composition. The colorant can be added to the composition in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the composition of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In an embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004, and incorporated herein by reference.

In general, the colorant can be present in the composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

In another embodiment, the compositions of the present invention when applied to a substrate as a coating possess color that matches the color of an associated substrate. As used herein, the term “matches” and like terms when referring to color matching means that the color of the coating composition of the present invention substantially corresponds to a desired color or the color of an associated substrate. This can be visually observed, or confirmed using spectroscopy equipment. For instance, when the substrate for the polyurea coating composition is a footwear component, such as a polymeric bladder or upper component, the color of the coating substantially matches that of another footwear component. For example, a toe coated according to the present invention can be color matched to the rest of the shoe upper, the midsole and/or the outsole. This match can be visually observed, or confirmed using spectroscopy equipment.

It will be appreciated that the present composition is a two-component (“2K”) composition. Accordingly, the isocyanate component and the amine component are kept separate until just prior to application. It will be understood that the composition can be cured at ambient conditions, although heated air or a heat cure can be applied to the composition in order to accelerate curing of the composition or to enhance coating properties such as adhesion. Additional components comprising other ingredients can be used based upon the needs of the user.

The compositions of the present invention are typically liquid. By “liquid” is meant that the compositions have a viscosity, measured as described above, that allows them to be at least extrudable; for example, less than 180,000 cps. The compositions may have a viscosity that allows them to be at least pumpable, and even at least sprayable. The isocyanate and the amine react to produce a composition that is cured upon application to a uncoated or coated substrate. Either package can also be heated prior to application, such as to a temperature of ≦70° C., such as 60° C. Heating may promote a better viscosity match between the two components and thus better mixing, but is not necessary for the curing reaction to occur.

Liquid compositions that are suitable for use in the present invention include liquid resin systems that are 100 percent solids, liquid resins that are dissolved or dispersed in a liquid medium, and solid particulate resins that are dispersed in a liquid medium. Liquid media may be aqueous based or organic solvent based. Often, the curable compositions of the present invention are essentially free of organic solvent and water, for example, containing less than three percent by weight of organic solvent and/or water, based on the total weight of the compositions.

The volume and/or weight mixing ratio of the isocyanate and amine may be such that the resulting isocyanate and amine reaction mixture can be applied to a substrate at a mixing ratio of 1:1. As used herein, “mixing ratio 1:1” means that the mixing ratio varies by up to 20% for each component, or up to 10% or up to 5%. Those skilled in the art would understand that other mix ratios are possible while maintaining the ratio of equivalents of isocyanate groups to equivalents of amine groups as greater than 1, since the first and second reactive components can be freely poured and mixed together in any suitable vessel or container. Any weight or volume mix ratio is possible; 1:1 is convenient.

It is believed that the ratio of equivalents of isocyanate groups to amine groups may be selected to control the rate of cure of the composition of the present invention. In certain embodiments, it has been found that cure and adhesion advantages may result when the ratio of the equivalents of isocyanate groups to amine groups (also known as the reaction index) is greater than one, such as from 1.01 to 1.10:1, or from 1.03 to 1.10:1, or from 1.05 to 1.08:1 or from 1.01 to 1.4 to 1 or from 1.01 to 1.5, or 1.3 or greater to 1. For example, good adhesion can be obtained using these ratios over clearcoats that have low surface functionality after cure, such as carbamate melamine, hydroxyl melamine, 2K urethane, and silane-containing clearcoats. The term “1:1 volume ratio” means that the volume ratio varies by up to 20% for each component, or up to 10% or up to 5%.

The composition of the present invention may be applied as a coating to a wide variety of substrates. The composition is also suitable for use as a mortar or caulk. Non-limiting examples of suitable substrates can include, but are not limited to, metal, natural and/or synthetic stone, ceramic, glass, brick, cement, concrete, cinderblock, wood and composites and laminates thereof; wallboard, drywall, sheetrock, cement board, plastic, paper, PVC, roofing materials such as shingles, roofing composites and laminates, and roofing drywall, styrofoam, plastic composites, acrylic composites, ballistic composites, asphalt, fiberglass, soil, gravel and the like. Metals can include but are not limited to aluminum, cold rolled steel, electrogalvanized steel, hot dipped galvanized steel, titanium and alloys; plastics can include but are not limited to TPO, SMC, TPU, polypropylene, polycarbonate, polyethylene, and polyamides (Nylon). The substrates can be primed metal and/or plastic; that is, an organic or inorganic layer is applied thereto. Further, the composition of the present invention can be applied to said substrates to impart one or more of a wide variety of properties such as but not limited to corrosion resistance, abrasion resistance, impact damage, flame and/or heat resistance, chemical resistance, UV light resistance, structural integrity, ballistic mitigation, blast mitigation, sound dampening, decoration and the like. As used herein, “ballistic mitigation” refers to reducing or alleviating the effects of a bullet or other type of firearm ammunition. As used herein, “blast mitigation” refers to reducing or alleviating the secondary effects of a blast. In non-limiting examples, the composition of the present invention can be applied to at least a portion of a building structure or an article of manufacture such as but not limited to a vehicle. “Vehicle” includes but is not limited to civilian, commercial, and military land-, water-, and air-vehicles, for example, cars, trucks, boats, ships, submarines, airplanes, helicopters, humvees and tanks. The article of manufacture can be a building structure. “Building structure” includes but is not limited to at least a portion of a structure including residential, commercial and military structures, for example, roofs, floors, support beams, walls and the like. “Building structure” also includes structures, including those that define apertures, associated with mining. Typical mine structures include mains, submains, gate road entries, production panels, bleeders, and other active working areas associated with underground mining. Accordingly, the present compositions can also be used to coat mine supports, beams, seals, stoppings, ribs, exposed strata, and the like and can be further used, alone or in conjunction with other layers, to seal and/or reinforce mine structures. As used herein, the term “substrate” may refer to a surface, either external or internal, on at least a portion of an article of manufacture or the article of manufacture itself. In an embodiment, the substrate is a truck bed.

The composition may be applied to the substrate by one or more of a number of methods including spraying, extruding, brushing, or by hand with a blade. Applying the composition to a substrate by hand with a blade, brush, or the like reduces the level of airborne reactants, compared to spray application.

The compositions can be cured by allowing them to stand at ambient temperature, or a combination of ambient temperature cure and baking, or by baking alone. The compositions can be cured at ambient temperature typically in a period ranging from about 2 hours to about 96 hours, usually 24 to 36 hours.

In certain embodiments of the present invention, at two hours after mixing of the reactive packages, the composition demonstrates a Young's Modulus of greater than 200 MPa, often greater than 300 MPa, at 23° C.

In some embodiments, at two hours after mixing of the reactive packages, the composition demonstrates a tensile strength of ≧5 MPa, such as 10 MPa, often at least 15 MPa, measured at 23° C.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

An amine component was prepared from the following ingredients as described below:

| | Example 1 | Example 2 |
|---|---|---|
| Ingredient | Wt. in parts | Wt. in parts |
| Jeffamine D2000 | 30 | 20 |
| Desmophen 1220¹ | 45 | 50 |
| PolyClear 136² | 25 | 30 |
| Total | 100.0 | 100.0 |

¹Available from Bayer Material Science Corp.
²Available from Hanson Group

The ingredients listed in the table above were then added together at ambient conditions.

Polyurea coating compositions of the invention were prepared from combining an isocyanate functional “A” side component and an amine functional “B” side component in the following manner: Polyurea coating compositions were produced by mixing a 1:1 volume ratio of each of the A-side components to each the B-side components in a static mix tube applicator device available from Plas-Pak Industries, Inc. The coating compositions were drawn down over polyethylene sheet to obtain free films. After 2 hours ambient cure, the free films were tested for tensile testing per ASTM D 638-08. The Gel time was determined by using a GARDCO Gel Timer by Paul N. Garner Company Inc.

TABLE 1

| Examples | 3 | 4 |
|---|---|---|
| Isocyanate “A side” | Desmodur | Desmodur |
| | XP-2580¹ | XP-2580¹ |
| Amine “B side” | Example 1 | Example 2 |
| Young's Modulus, MPa | 44.86 | 475.46 |
| (ASTM D638-08) | | |
| Tensile Strength, MPa | 8.9 | 17.38 |
| (ASTM D638-08) | | |
| % Elongation | 328.0 | 198.9 |
| (ASTM D638-08) | | |
| Gel time (sec.) | 76 | 48 |

¹Available from Bayer Material Science Corp

As can be seen from Table 1, Example 2 exhibits high Young's modulus and tensile strength with a fast gel time that is suitable for a high strength mortar or caulk to bond cement or composite blocks together or other components. Properties can be modified to increase or decrease Young's modulus, tensile strength, and gel time.

What is claimed is:

1. A curable, two-package composition comprising a first and second reactive package, wherein the first reactive package comprises:
a) a polyether functional polyamine;
b) a polyamine comprising an aspartic ester functional polyamine and/or a hindered amine of the structure I: 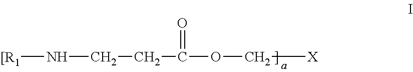
where R₁ represents a hydrocarbon radical; X represents an organic group; and a is an integer from 1 to 20; and/or II: 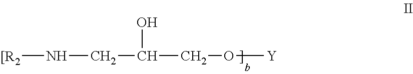
where R₂ represents a hydrocarbon radical; Y represents an organic group; and b is an integer from 1 to 10; and
c) an aliphatic secondary polyamine different from (a) and (b);
and wherein the second reactive package comprises a polyisocyanate having a viscosity of ≦2000 centipoise (cPs) at a temperature≧7° C.; and wherein the curable composition, upon mixing of the reactive packages at ambient temperature, demonstrates a gel time of less than 120 seconds.

2. The curable composition according to claim 1, wherein the polyamine (b) comprises an aspartic ester functional polyamine containing linear groups.

3. The curable composition according to claim 1, wherein the curable composition, upon mixing of the reactive packages, demonstrates a gel time of less than 100 seconds at ambient temperature.

4. The curable composition according to claim 1, wherein the first reactive package further comprises an aromatic diamine.

5. The curable composition according to claim 1, wherein the polyether functional polyamine (a) comprises diamines and/or triamines.

6. The curable composition according to claim 1, wherein the aliphatic secondary polyamine comprises a diamine having an amine equivalent weight of up to 200.

7. The curable composition according to claim 1, wherein the first reactive package further comprises a pigment and/or rheology modifier.

8. The curable composition according to claim 7, wherein a pigment is present comprising TiO₂.

9. The curable composition according to claim 7, wherein a rheology modifier is present.

10. The curable composition according to claim 9, wherein the rheology modifier comprises fumed silica.

11. The curable composition according to claim 9, wherein the rheology modifier comprises clay selected from montmorillonite clays, kaolin clays, attapulgite clays, sepiolite clay, and mixtures thereof.

12. The curable composition according to claim 11, wherein the clay comprises surface-treated bentonite.

13. The curable composition according to claim 1, wherein the polyamine (b) comprises an aspartic ester functional polyamine, present in the first reactive package in an amount of 30 to 65 percent by weight, based on the total weight of solids in the first reactive package.

14. The curable composition according to claim 1, wherein the first reactive package further comprises an additional resin that is different from any of the amines, and that may or may not be reactive with the polyisocyanate.

15. The curable composition according to claim 14, wherein the additional resin comprises a polyether, a polycarbonate and/or a polyester.

16. The curable composition according to claim 1, wherein the polyisocyanate comprises an aliphatic polyisocyanate derived from hexamethylene diisocyanate.

17. The curable composition according to claim 1, wherein the second reactive package further comprises a catalyst.

18. The curable composition according to claim 1, wherein either the weight ratio or the volume ratio of the first reactive package to the second reactive package is 1:1.

19. The curable composition according to claim 1 wherein at two hours after mixing of the reactive packages, the composition demonstrates a Young's Modulus of greater than 300 MPa at 23° C.

20. The curable composition according to claim 1 wherein at two hours after mixing of the reactive packages, the composition demonstrates a tensile strength of at least 15 MPa at 23° C.
